(19) United States
(12) Patent Application Publication
(10) Pub. No.: US 2023/0303851 A1
(43) Pub. Date: Sep. 28, 2023

(54) COATING AGENT FOR RESIN GLASS AND RESIN GLASS

(71) Applicants: KABUSHIKI KAISHA TOYOTA JIDOSHOKKI, Kariya-shi, Aichi (JP); KANSAI PAINT CO., LTD., Amagasaki-shi, Hyogo (JP)

(72) Inventors: Hidenori MUNEKATA, Aichi (JP); Motoshige ISOBE, Aichi (JP); Sayako SATO, Aichi (JP); Ken NODA, Aichi (JP); Kota GOTO, Kanagawa (JP); Naoko AGARI, Kanagawa (JP)

(73) Assignees: KABUSHIKI KAISHA TOYOTA JIDOSHOKKI, Kariya-shi, Aichi (JP); KANSAI PAINT CO., LTD., Amagasaki-shi, Hyogo (JP)

(21) Appl. No.: 18/011,371

(22) PCT Filed: Mar. 22, 2021
(86) PCT No.: PCT/JP2021/011700

§ 371 Date: Dec. 19, 2022

(30) Foreign Application Priority Data
Aug. 26, 2020 (JP) 2020-142609

(51) Int. Cl. C09D 4/06; C09D 135/02; C09D 175/14; C08J 7/04

(52) U.S. Cl. CPC C09D 4/06; C08J 7/0427; C09D 135/02; C09D 175/14; C08J 2369/00; C08J 2435/02; C08J 2475/14

(57) ABSTRACT

A coating agent includes: a film forming component including a component A consisting of a urethane (meth)acrylate having an isocyanuric ring skeleton, a component B consisting of a tri(meth)acrylate having an isocyanuric ring skeleton and having no urethane bond, a component C consisting of a polymerizable urethane which has a polycarbonate skeleton derived from a polycarbonate diol having an alicyclic structure, 3 or more polymerizable unsaturated groups per molecule, a weight average molecular weight of 10,000 to 40,000, and a content ratio of the alicyclic structure of 10 mass% to 25 mass%, and a component D consisting of colloidal silica having a (meth)acryloyl group; and a component E consisting of a photoradical polymerization initiator. The content of the component E is 0.1 to 10 parts by mass based on 100 parts by mass of the total film forming component.

### TECHNICAL FIELD

The present invention relates to a coating agent for resin glass and resin glass.

### BACKGROUND ART

Heretofore, windows of vehicles such as automobiles and trains have been made of inorganic glass. In recent years, studies have been conducted on replacement of inorganic glass for forming windows and the like with resin glass made of transparent resin lighter than inorganic glass for the purpose of weight reduction of vehicles. However, there is a problem that resin glass has lower abrasion resistance and weather resistance as compared to inorganic glass.

A technique has been proposed in which a hard film is formed on a surface of transparent resin for solving the above-mentioned problem to improve the abrasion resistance and weather resistance of resin glass. For example, Patent Document 1 discloses a method for forming a covered polycarbonate plate-shaped molded product including a polycarbonate plate-shaped molded product, a primer layer provided on at least one surface of the molded product, and a hard coat layer formed on the primer layer. The hard coat layer is formed by curing a hard coat coating liquid containing colloidal silica and a hydrolysis condensate of trialkoxysilane with application of heat.

This type of plate-shaped molded product may have a curved shape for the purpose of, for example, improving the design property in some cases. For forming a film on a surface of a curved plate-shaped molded product, a method is used in which a plate-shaped molded product molded in a desired shape in advance is prepared, and a film is formed on the surface of the plate-shaped molded product.

### PRIOR ART LITERATURE

### Patent Documents

Patent Document 1: Japanese Patent Laid-Open No. 2004-27110

### SUMMARY OF THE INVENTION

### Problems to Be Solved by the Invention

However, for forming a film having a two-layer structure of a primer layer and a hard coat layer as in the covered polycarbonate plate-shaped molded product of Patent Document 1, it is necessary to sequentially carry out a step of applying a primer onto the plate-shaped molded product, a step of drying the primer to form a primer layer, a step of applying a coating agent onto the primer layer, and a step of curing the coating agent to form a hard coat layer. Thus, the work of forming the film is complicated, and the cost required for the work of forming the film increases.

In addition, the film described in Patent Document 1 has low toughness, and therefore has a problem that the film cannot follow deformation of the plate-shaped molded product due to thermal expansion or the like, and thus cracks are likely to be generated.

The present invention has been made in view of such a background, and an object of the present invention is to provide a coating agent for resin glass which enables formation of a coating film having both high hardness and excellent toughness by a simple method, and resin glass prepared by using the coating agent for resin glass.

### Means for Solving the Problems

One aspect of the present invention is a coating agent for resin glass comprising:
a film forming component including
   a component A consisting of a urethane (meth)acrylate having an isocyanuric ring skeleton,
   a component B consisting of a tri(meth)acrylate having an isocyanuric ring skeleton and having no urethane bond,
   a component C consisting of a polymerizable urethane which has
      a polycarbonate skeleton derived from a polycarbonate diol having an alicyclic structure,
      3 or more polymerizable unsaturated groups per molecule,
      a weight average molecular weight of 10,000 or more and 40,000 or less, and
      a content ratio of the alicyclic structure of 10 mass% or more and 25 mass% or less, and
   a component D consisting of colloidal silica having a (meth)acryloyl group; and
a component E consisting of a photoradical polymerization initiator,
wherein a content of the component E is 0.1 parts by mass or more and 10 parts by mass or less based on 100 parts by mass of the total film forming component.

Another aspect of the present invention is resin glass including a substrate including a transparent resin, and

a coating film including a cured product of the coating agent for resin glass according to the above-described aspect, and covering a surface of the substrate.

### Effects of the Invention

The coating agent for resin glass (hereinafter, referred to as a “coating agent”) contains a film forming component including the components A to D and the component E consisting of a photoradical polymerization initiator. The components A to D all have a photoradical polymerizable functional group such as a (meth)acryloyl group. Thus, by a simple method in which the coating agent is applied onto a substrate, and the coating agent is then irradiated with light to generate radicals from the component E, the film forming component can be cured to form a coating film.

The coating film obtained by curing the coating agent has a network structure formed by three-dimensional crosslinking of the components, and therefore has high hardness. In addition, the network structure of the coating film includes a structure derived from the C component which has a polycarbonate skeleton including an alicyclic structure and has a relatively large molecular weight. This enables improvement of the toughness of the coating film.

Therefore, according to the above-described aspect, it is possible to provide a coating agent for resin glass which enables formation of a coating film having both high hardness and excellent toughness by a simple method.

### MODES FOR CARRYING OUT THE INVENTION

### Coating Agent for Resin Glass

The film forming component in the coating agent includes components A to D. By curing the coating agent containing these components, a coating film having both high hardness and excellent toughness can be formed. The coating film obtained by curing the coating agent is also excellent in adhesion to a substrate, abrasion resistance, and weather resistance. Hereinafter, each component contained in the coating agent will be described.

### Component A: Urethane (Meth)Acrylate Having Isocyanuric Ring Skeleton

The coating agent contains, as an essential component, a component A consisting of a urethane (meth)acrylate having an isocyanuric ring skeleton. By blending the component A in the coating agent, the weather resistance of the coating film obtained by curing the coating agent can be improved.

The content of the component A in the coating agent is preferably 3 parts by mass or more and 60 parts by mass or less based on 100 parts by mass of the film forming component. In this case, the effect of improving the weather resistance by the component A is secured, and a sufficiently large content of components other than the component A is maintained, so that the action and effect of these components can be enhanced in a well-balanced manner. As a result, the hardness, adhesion to the substrate, abrasion resistance, weather resistance, and toughness, of the coating film can be improved in a well-balanced manner. From the viewpoint of further enhancing such an action and effect, the content of the component A in the coating agent is more preferably 20 parts by mass or more and 60 parts by mass or less, still more preferably 30 parts by mass or more and 60 parts by mass or less, particularly preferably 35 parts by mass or more and 60 parts by mass or less, based on 100 parts by mass of the film forming component.

As the component A, for example, a compound represented by the following general formula (1) can be employed. The compound represented by the following general formula (1) can be synthesized by, for example, an addition reaction between a nurate-type trimer of hexamethylene diisocyanate and a hydroxyalkyl (meth)acrylate or an ε-caprolactone-modified product thereof. As the component A, one compound selected from these compounds may be used, or two or more of these compounds may be used in combination.

### Chemical Formula 1

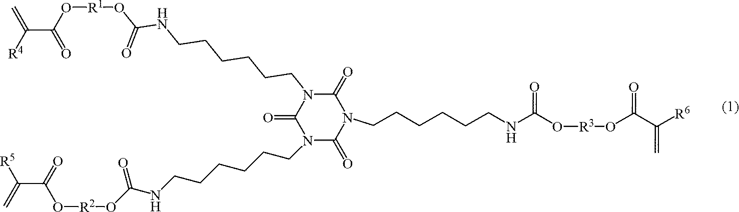

Each of R¹, R², and R³ in the general formula (1) is a divalent organic group having 2 to 10 carbon atoms. R¹, R², and R³ may be the same organic group, or mutually different organic groups. When an ε-caprolactone-modified product of a hydroxyalkyl (meth)acrylate is added to a nurate-type trimer of hexamethylene diisocyanate, the above-described divalent organic group includes the partial structure of -COCH₂CH₂CH₂CH₂CH₂-or -OCOCH₂CH₂CH₂CH₂CH₂-.

R¹, R², and R³ are each preferably an alkylene group having 2 to 4 carbon atoms, such as an ethylene group, a trimethylene group, a propylene group, or a tetramethylene group, and more preferably a tetramethylene group. In this case, the abrasion resistance and weather resistance of the coating film can be further improved.

Each of R⁴, R⁵, and R⁶ in the general formula (1) is a hydrogen atom or a methyl group. R⁴, R⁵, and R⁶ may be the same, or mutually different. R⁴, R⁵, and R⁶ are each preferably a hydrogen atom. In this case, the curability of the coating agent can be further improved.

The addition reaction between a nurate-type trimer of hexamethylene diisocyanate and a hydroxyalkyl (meth)acrylate or an ε-caprolactone-modified product thereof may be carried out without using a catalyst, or may be carried out using a catalyst for accelerating the reaction. As the catalyst, for example, a tin-based catalyst such as dibutyltin dilaurate or an amine-based catalyst such as triethylamine can be used.

### Component B: Tri(meth)acrylate Having Isocyanuric Ring Skeleton and Having No Urethane Bond

The coating agent contains, as an essential component, a component B consisting of a tri(meth)acrylate having an isocyanuric ring skeleton and having no urethane bond. By blending the component B in the coating agent, the weather resistance of the coating film after curing can be improved, and adhesion between the coating film and the substrate can be improved.

The content of the component B in the coating agent is preferably 10 parts by mass or more and 50 parts by mass or less based on 100 parts by mass of the film forming component. In this case, the effect of improving the weather resistance and adhesion by the component B is secured, and a sufficiently large content of components other than the component B is maintained, so that the action and effect of these components can be enhanced in a well-balanced manner. As a result, the hardness, adhesion to the substrate, abrasion resistance, weather resistance, and toughness, of the coating film can be improved in a well-balanced manner.

From the viewpoint of further enhancing such an action and effect, the content of the component B in the coating agent is more preferably 10 parts by mass or more and 45 parts by mass or less, still more preferably 10 parts by mass or more and 40 parts by mass or less, particularly preferably 10 parts by mass or more and 30 parts by mass or less, based on 100 parts by mass of the film forming component.

As the component B, for example, a compound represented by the following general formula (2), or the like can be used. The compound represented by the following general formula (2) can be synthesized by, for example, a condensation reaction between an alkylene oxide adduct of isocyanuric acid and (meth)acrylic acid or an ε-caprolactone-modified product thereof. As the component B, one compound selected from these compounds may be used, or two or more of these compounds may be used in combination.

### Chemical Formula 2

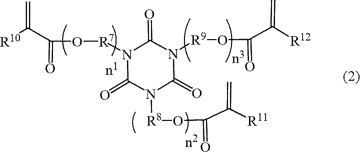

Each of R⁷, R⁸, and R⁹ in the general formula (2) is a divalent organic group having 2 to 10 carbon atoms. In addition, n¹ is 1 to 3, n² is 1 to 3, n³ is 1 to 3, and n¹ + n² + n³ is 3 to 9. The value of n¹ + n² + n³ represents an average number of moles of the alkylene oxide added per molecule of a compound of the general formula (2).

R⁷, R⁸, and R⁹ in the general formula (2) may be the same organic group, or mutually different organic groups. n¹, n², and n³ may be the same value, or mutually different values. When an ε-caprolactone-modified product of (meth)acrylic acid is condensed with isocyanuric acid, the above-described divalent organic group includes the partial structure of —COCH₂CH₂CH₂CH₂CH₂— or —OCOCH₂CH₂CH₂CH₂CH₂—.

R⁷, R⁸, and R⁹ in the general formula (2) are each preferably an alkylene group having 2 to 4 carbon atoms, such as an ethylene group, a trimethylene group, a propylene group, or a tetramethylene group, and more preferably an ethylene group. In this case, the abrasion resistance and weather resistance of the coating film can be further improved.

The value of n¹, the value of n², and the value of n³ in the general formula (2) are each preferably 1. In this case, the adhesion of the coating film to the substrate can be further improved.

Each of R¹⁰, R¹¹, and R¹² in the general formula (2) is a hydrogen atom or a methyl group. R¹⁰, R¹¹, and R¹² may be the same, or mutually different. R¹⁰, R¹¹, and R¹² are each preferably a hydrogen atom. In this case, the curability of the coating agent can be further improved.

### Component C: Polymerizable Urethane

The coating agent contains, as an essential component, a component C consisting of a polymerizable urethane which has a polycarbonate skeleton derived from a polycarbonate diol having an alicyclic structure, 3 or more polymerizable unsaturated groups per molecule, a weight average molecular weight of 10,000 or more and 40,000 or less, and a content ratio of the alicyclic structure of 10 mass% or more and 25 mass% or less. By blending the component C in the coating agent, the toughness of the coating film after curing can be improved. The improvement of the toughness of the coating film enables suppression of generation of cracks in the coating film due to, for example, thermal expansion of resin glass.

The content of the component C in the coating agent is preferably 10 parts by mass or more and 50 parts by mass or less based on 100 parts by mass of the film forming component. In this case, the effect of improving the toughness by the component C is secured, and a sufficiently large content of components other than the component C is maintained, so that the action and effect of these components can be enhanced in a well-balanced manner. As a result, the hardness, adhesion to the substrate, abrasion resistance, weather resistance, and toughness, of the coating film can be improved in a well-balanced manner.

The number of polymerizable unsaturated groups contained in the component C is 3 or more per molecule. This can increase the crosslinking density of the coating film thereby forming a hard coating film. From the viewpoint of securing both the hardness and the toughness of the coating film, the number of polymerizable unsaturated groups contained in the component C is preferably 3 or more and 10 or less, more preferably 4 or more and 6 or less, per molecule.

Examples of the polymerizable unsaturated group contained in the component C include a (meth)acryloyl group, a vinyl group, a propenyl group, a butadienyl group, a styryl group, an ethynyl group, a cinnamoyl group, a maleate group, and an acrylamide group. From the viewpoint of curability, the polymerizable unsaturated group contained in the component C is preferably a (meth)acryloyl group, more preferably an acryloyl group.

The weight average molecular weight of the component C is 10,000 or more and 40,000 or less. By setting the weight average molecular weight of the component C to 10,000 or more, the toughness of the coating film can be improved. By setting the weight average molecular weight of the component C to 40,000 or less, the hardness, abrasion resistance, weather resistance, and adhesion to the substrate, of the coating film can be improved. From the viewpoint of enhancing the various properties described above in a well-balanced manner, the weight average molecular weight of the component C is preferably 10,000 or more and 30,000 or less, more preferably 11,000 or more and 25,000 or less, still more preferably 12,000 or more and 18,000 or less.

The weight average molecular weight of the component C is a value of a weight average molecular weight in terms of polystyrene, which is obtained by gel permeation chromatography (GPC). Specific GPC measurement conditions are as follows.
Apparatus: HPLC-8220 (manufactured by TOSOH CORPORATION)
Column configuration: TSKgel SuperHZ3000 + TSKgel SuperHZ1000 (all manufactured by TOSOH CORPORATION)
Detector: differential refractive index detector
Eluting solution: tetrahydrofuran
Flow rate of eluting solution: 0.6 mL/min
Temperature: 40° C.
Calibration: in terms of polystyrene
Sample concentration: 0.01 g/5 mL

The content ratio of the alicyclic structure in the component C is 10 mass% or more and 25 mass% or less based on the content of the component C. This enables well-balanced improvement of the toughness, hardness, adhesion to the substrate, abrasion resistance, and weather resistance, of the coating film. From the viewpoint of further enhancing such an action and effect, the content ratio of the alicyclic structure in the component C is more preferably 15 mass% or more and 20 mass% or less based on the content of the component C. The content of the alicyclic structure described above is a theoretical value calculated from the structural formula of a raw material used in synthesis of the compound and the ratio of the raw material used.

The above-described “alicyclic structure” refers to, for example, a ring structure having no aromatic property (i.e., no π-electron conjugated system), such as a cyclic saturated aliphatic hydrocarbon group or a cyclic unsaturated aliphatic hydrocarbon group.

The “alicyclic structure” conceptually includes not only a ring structure including only carbon atoms but also a heterocyclic structure containing hetero atoms as constituent atoms.

As the component C, for example, commercially available polymerizable urethane can be used. Examples of commercially available products that can be used as the component C include “UA0581B”, “UA0499B”, “UA0582B-30”, “UA0592B”, “UA0503B”, “UA0505B”, and “UA0500B” manufactured by Ube Industries, Ltd. As the component C, for example, polymerizable urethane generated by a reaction of a polycarbonate diol (c1) having an alicyclic structure, a polyisocyanate compound (c2), and a polymerizable unsaturated compound (c3) can also be used.

### Polycarbonate Diol Having Alicyclic Structure (c1)

As the polycarbonate diol (c1) having an alicyclic structure, a compound containing a structural unit derived from an alicyclic diol and a carbonate group can be used. The polycarbonate diol (c1) may further contain a structural unit derived from a diol having no alicyclic structure.

The content ratio of the alicyclic structure in the polycarbonate diol (c1) is preferably 5 mass% or more and 20 mass% or less, more preferably 8 mass% or more and 15 mass% or less, based on the content of the C component. By setting the content ratio of the alicyclic structure in the polycarbonate diol (c1) within the above-mentioned specific range, the hardness and toughness of the coating film can be improved in a well-balanced manner.

The polycarbonate diol (c1) can be obtained by, for example, polycondensation reaction of an alicyclic diol with a carbonylating agent.

Examples of the alicyclic diol for use in synthesis of the polycarbonate diol (c1) include 1,3-cyclohexanediol, 1,4-cyclohexanediol, and 1,4-cyclohexanedimethanol. These alicyclic diols may be used alone, or in combination of two or more thereof.

The carbonylating agent for use in synthesis of the polycarbonate diol (c1) is not particularly limited as long as it is a carbonylating agent that can be used for production of polycarbonate. Examples of the carbonylating agent include alkylene carbonates, dialkyl carbonates, diallyl carbonates, and phosgene. These carbonylating agents may be used alone, or in combination of two or more thereof. As the carbonylating agent, it is preferable to use one or more selected from the group consisting of ethylene carbonate, propylene carbonate, dimethyl carbonate, diethyl carbonate, dibutyl carbonate, and diphenyl carbonate.

As the polycarbonate diol (c1) having an alicyclic structure, a commercially available product can also be used. Examples of the commercially available product include “ETERNACOLL UC-100” (diol component: 1,4-cyclohexanedimethanol) and “ETERNACOLL UM-90 (1/1)” (diol components: 1,6-hexanediol and 1,4-cyclohexanedimethanol) manufactured by Ube Industries, Ltd. “ETERNACOLL” is a registered trademark owned by Ube Industries, Ltd.

### Polyisocyanate Compound (c2)

As the polyisocyanate compound (c2), a compound having at least two isocyanate groups per molecule can be used. Examples of the polyisocyanate compound (c2) include aliphatic polyisocyanates, alicyclic polyisocyanates, araliphatic polyisocyanates, aromatic polyisocyanates, and derivatives of these polyisocyanates. These polyisocyanate compounds (c2) may be used alone, or in combination of two or more thereof.

Examples of the aliphatic polyisocyanate include: aliphatic diisocyanates such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, dimer acid diisocyanate, and methyl 2,6-diisocyanatohexanoate (common name: lysine diisocyanate); and aliphatic triisocyanates such as 2-isocyanatoethyl 2,6-diisocyanatohexanoate, 1,6-diisocyanato-3-isocyanatomethylhexane, 1,4,8-triisocyanatooctane, 1,6,11-triisocyanatoundecane, 1,8-diisocyanato-4-isocyanatomethyloctane, 1,3,6-triisocyanatohexane, and 2,5,7-trimethyl-1,8-diisocyanato-5-isocyanatomethyloctane.

Examples of the alicyclic polyisocyanate include: alicyclic diisocyanates such as 1,3-cyclopentene diisocyanate, 1,4-cyclohexane diisocyanate, 1,3-cyclohexane diisocyanate, 3-isocyanatomethyl-3,5,5-trimethylcyclohexyl isocyanate (common name: isophorone diisocyanate), methyl-2,4-cyclohexane diisocyanate, methyl-2,6-cyclohexane diisocyanate, 1,3- or 1,4-bis (isocyanatomethyl)cyclohexane (common name: hydrogenated xylylene diisocyanate) or mixtures thereof, methylenebis(1,4-cyclohexanediyl)diisocyanate (common name: hydrogenated MDI), and norbornane diisocyanate; and alicyclic triisocyanates such as 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo (2.2.1)heptane, 5-(2-isocyanatoethyl)-2-isocyanatomethyl-3-(3-isocyanatopropyl)-bicyclo (2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl -2-(3-isocyanatopropyl)-bicyclo (2.2.1)-heptane, and 6-(2-isocyanatoethyl)-2-isocyanatomethyl -2-(3-isocyanatopropyl)-bicyclo(2.2.1)heptane.

Examples of the araliphatic polyisocyanate include: araliphatic diisocyanates such as methylenebis(1,4-phenylene)diisocyanate (common name: MDI), 1,3- or 1,4-xylylene diisocyanate or mixtures thereof, ω,ω′-diisocyanato-1,4-diethylbenzene, and 1,3- or 1,4-bis(1-isocyanato-1-methylethyl)benzene (common name: tetramethylxylylene diisocyanate) or mixtures thereof; and araliphatic triisocyanates such as 1,3,5-triisocyanatomethylbenzene.

Examples of the aromatic polyisocyanate include: aromatic diisocyanates such as m-phenylene diisocyanate, p-phenylene diisocyanate, 4,4′-diphenyl diisocyanate, 1,5-naphthalene diisocyanate, 2,4- or 2,6-tolylene diisocyanate or mixtures thereof, 4,4′-toluidine diisocyanate, and 4,4′-diphenyl ether diisocyanate; aromatic triisocyanates such as triphenylmethane-4,4′,4″-triisocyanate, 1,3,5-triisocyanatobenzene, and 2,4,6-triisocyanatotoluene; and aromatic tetraisocyanates such as 4,4′-diphenylmethane-2,2′,5,5′-tetraisocyanate.

Examples of the derivative of polyisocyanate include dimers, trimers, biurets, allophanates, uretdiones, uretonimines, isocyanurates, oxadiazinetriones, polymethylene polyphenyl polyisocyanates (crude MDI and polymeric MDI), and crude TDI from the above-described polyisocyanate compounds.

As the polyisocyanate compound (c2), it is preferable to use an alicyclic diisocyanate from the viewpoint of the hardness and weather resistance of the coating film.

### Polymerizable Unsaturated Compound (c3)

As the polymerizable unsaturated compound (c3), a compound having a hydroxide group and a polymerizable unsaturated group can be used.

Examples of the polymerizable unsaturated compound (c3) include 2-hydroxyethyl (meth)acrylate, 2-hydroxypropyl (meth)acrylate, 3-hydroxypropyl (meth)acrylate, 4-hydroxybutyl (meth)acrylate, glycerin di(meth)acrylate, trimethylolpropane di(meth)acrylate, pentaerythritol di(meth) acrylate, pentaerythritol tri(meth)acrylate, dipentaerythritol penta(meth)acrylate, and tris(2-hydroxyethyl)isocyanurate di(meth)acrylate. These polymerizable unsaturated compounds (c3) may be used alone, or in combination of two or more thereof.

From the viewpoint of the hardness and weather resistance of the coating film, as the polymerizable unsaturated compound (c3), it is preferable to use pentaerythritol tri(meth)acrylate and/or dipentaerythritol penta(meth)acrylate, more preferable to use pentaerythritol triacrylate and/or dipentaerythritol pentaacrylate, still more preferable to use pentaerythritol triacrylate.

### <Synthesis of Component C>

For synthesizing the component C, for example, the polycarbonate diol (c1) derived from an alicyclic structure, the polyisocyanate compound (c2), and the polymerizable unsaturated compound (c3) may be subjected to condensation polymerization by a known urethanization reaction. For introducing a structural unit derived from a compound other than the above-described compounds into the component C, the above-described condensation polymerization may be performed by subjecting said compound, which is other than these compounds, to condensation polymerization as well as the polycarbonate diol (c1), the polyisocyanate compound (c2), and the polymerizable unsaturated compound (c3).

The urethanization reaction can be carried out in an organic solution. Examples of the organic solvent include; aromatic hydrocarbon-based solvents such as toluene and xylene; ketone-based solvents such as acetone, methyl ethyl ketone, methyl isobutyl ketone, and cyclohexanone; and ester-based solvents such as ethyl acetate, propyl acetate, isobutyl acetate, and butyl acetate. These organic solvents may be used alone, or in combination of two or more thereof.

The reaction temperature for the urethanization reaction is preferably within the range of normal temperature to 100° C. The reaction time for the urethanization reaction is preferably within the range of 1 hour or more and 10 hours or less.

In the urethanization reaction, the status of progress of the reaction can be checked by tracking the isocyanate equivalent of the reaction liquid. The isocyanate equivalent can be determined by back titration using dibutylamine. Specifically, the back titration can be performed by adding an excessive amount of dibutylamine to a sample to react the mixture, and titrating the remaining dibutylamine with an aqueous hydrochloric acid solution using bromophenol blue as a titration indicator.

In the urethanization reaction, an organotin catalyst such as dibutyltin dilaurate, dibutyltin diethylhexoate, or dibutyltin sulfite may be used, as necessary. The amount of the catalyst is preferably 0.01 parts by mass or more and 1.0 part by mass or less, and more preferably 0.1 parts by mass or more and 0.5 parts by mass or less, based on 100 parts by mass of all reaction raw materials.

In the urethanization reaction, a polymerization inhibitor such as hydroquinone monomethyl ether may be used. When the polymerization inhibitor is used, the amount of the polymerization inhibitor added is preferably 0.01 parts by mass or more and 1.0 parts by mass or less, based on 100 parts by mass of all reaction raw materials.

### Component D: Colloidal Silica Having (meth)Acryloyl Group

The coating agent contains, as an essential component, a component D consisting of colloidal silica having a (meth)acryloyl group. By blending the component D in the coating agent, the curability of the coating agent can be improved, and the abrasion resistance and water resistance of the coating film after curing can be improved.

The component D is preferably colloidal silica having a (meth)acryloyl group and a hydrocarbon group. In this case, the weather resistance and water resistance of the coating film can be further improved. From the viewpoint of further enhancing the above-described action and effect, the number of carbon atoms in the hydrocarbon group is preferably 3 or more and 13 or less, more preferably 4 or more and 8 or less.

The content of the component D in the coating agent is preferably 1 part by mass or more, more preferably 3 parts by mass or more, still more preferably 5 parts by mass or more, based on 100 parts by mass of the film forming component. In this case, the abrasion resistance of the coating film can be further improved.

The content of the component D in the coating agent is preferably 30 parts by mass or less, more preferably 25 parts by mass or less, still more preferably 20 parts by mass or less, based on 100 parts by mass of the film forming component. In this case, the effect of improving the curability and abrasion resistance by the component D is secured, and a sufficiently large content of components other than the component D is maintained, so that the action and effect of these components can be enhanced in a well-balanced manner. As a result, the hardness, adhesion to the substrate, abrasion resistance, weather resistance, and toughness, of the coating film can be improved in a well-balanced manner.

As the component D, for example, a substance obtained by chemically modifying colloidal silica (d1) using a silane coupling agent (d2) having a (meth)acryloyl group, a substance obtained by chemically modifying colloidal silica (d1) using the silane coupling agent (d2) having a (meth)acryloyl group and a silane coupling agent (d3) having a hydrocarbon group, or the like can be used.

The colloidal silica (d1) used for preparing the component D may have, for example, an alcohol-based dispersion medium, and silica primary particles dispersed in the alcohol-based dispersion medium. The silica primary particles may be present in a state of being separated from one another in the alcohol-based dispersion medium, or may be present as secondary particles formed by aggregation of a plurality of silica primary particles.

The average primary particle size of the silica primary particles is preferably 1 nm or more and 50 nm or more, and more preferably 1 nm or more and 30 nm or less. By setting the average primary particle size of the silica primary particles to 1 nm or more, the abrasion resistance of the coating film after curing can be further improved. By setting the average primary particle size of the silica primary particles to 50 nm or less, the dispersion stability of colloidal silica can be further improved.

The average primary particle size of the silica primary particles can be calculated on the basis of a specific surface area measured by the BET method. For example, when the average primary particle size of the silica primary particles is 1 nm or more and 50 nm or less, the specific surface area measured by the BET method is 30 m²/g or more and 3000 m²/g or less.

As the silane coupling agent (d2) having a (meth)acryloyl group, which is reacted with the colloidal silica (d1), for example, 3-(meth)acryloyloxypropyltrimethoxysilane, 3-(meth)acryloyloxypropyltriethoxysilane, 2-(meth)acryloyloxyethyltrimethoxysilane, 2-(meth)acryloyloxyethyltriethoxysilane, 3-(meth)acryloyloxypropylmethyldimethoxysilane, 2-(meth)acryloyloxyethylmethyldimethoxysilane, vinyltrimethoxysilane, vinyltriethoxysilane, allyltrimethoxysilane, allyltriethoxysilane, or the like can be used. These silane coupling agents (d2) may be used alone, or in combination of two or more thereof.

As the silane coupling agent (d3) having a hydrocarbon group, which is reacted with the colloidal silica (d1), for example, methyltrimethoxysilane, ethyltrimethoxysilane, propyltrimethoxysilane, isopropyltrimethoxysilane, butyltrimethoxysilane, cyclohexyltrimethoxysilane, hexyltrimethoxysilane, octyltrimethoxysilane, decyltrimethoxysilane, dodecyltrimethoxysilane, phenyltrimethoxysilane, or the like can be used. The number of carbon atoms in the hydrocarbon group in the silane coupling agent (d3) is preferably 3 or more and 13 or less, more preferably 4 or more and 8 or less. These silane coupling agents (d3) may be used alone, or in combination of two or more thereof.

In synthesis of the component D, for example, a method can be employed in which colloidal silica (d1) is reacted with the silane coupling agent (d2) in the presence of an organic solvent. The amount of the silane coupling agent (d2) added is preferably 10 parts by mass or more and 40 parts by mass or less, more preferably 10 parts by mass or more and 30 parts by mass or less, based on 100 parts by mass of the silica primary particles.

For preparing colloidal silica having a (meth)acryloyl group and a hydrocarbon group as the component D, for example, a method can be employed in which colloidal silica (d1) is reacted with the silane coupling agent (d2) and the silane coupling agent (d3) in the presence of an organic solvent. In this case, the amount of the silane coupling agent (d2) added is preferably 10 parts by mass or more and 40 parts by mass or less, more preferably 10 parts by mass or more and 30 parts by mass or less based on 100 parts by mass of the silica primary particles. In addition, the amount of the silane coupling agent (d3) added is preferably more than 0 part by mass and 30 parts by mass or less, more preferably 5 parts by mass or more and 20 parts by mass or less, based on 100 parts by mass of the silica primary particles.

### Component E: Photoradical Polymerization Initiator

The coating agent contains, as an essential component, a component E consisting of a photoradical polymerization initiator. The component E can generate radicals in the coating agent when the coating agent is irradiated with light having a specific wavelength which depends on the molecular structure of the component E. The radicals can initiate a polymerization reaction between photoradical polymerizable functional groups contained in the film forming component, such as (meth)acryloyl groups.

The content of the component E in the coating agent is 0.1 parts by mass or more and 10 parts by mass or less based on 100 parts by mass of the film forming component. By setting the content of the component E in the coating agent to 0.1 parts by mass or more, the coating agent disposed on the substrate can be cured to form a coating film.

When the content of the component E is less than 0.1 parts by mass, the amount of radicals as an initiation point of the polymerization reaction is insufficient, and therefore it is difficult to sufficiently cure the coating agent. As a result, the hardness of the coating film may decrease, leading to deterioration of durability against scratches. In this case, there may be a problem that adhesion of the coating film to the substrate decreases, or weather resistance is deteriorated.

On the other hand, an excessively large content of the component E may cause deterioration of the storage stability of the coating agent such as an increased possibility that an unintended radical polymerization reaction is initiated during storage of the coating agent. In this case, an unreacted polymerization initiator is likely to remain in the coating film after curing. An excessively large amount of the unreacted polymerization initiator remaining in the coating film may accelerate degradation of the coating film. Further, in this case, there is also a possibility of causing an increase in material cost.

By setting the content of the component E to 10 parts by mass or less, a sufficiently large amount of radicals as an initiation point of the polymerization reaction is maintained while the above-described problems are avoided, so that it is possible to sufficiently cure the coating agent.

As the component E, for example, an acetophenone-based compound, a benzophenone-based compound, an α-ketoester-based compound, a phosphine oxide-based compound, a benzoin compound, a titanocene-based compound, an acetophenone/benzophenone hybrid-based photoinitiator, an oxime ester-based photoinitiator, camphorquinone, or the like can be used.

Examples of the acetophenone-based compound include 2,2-dimethoxy-1,2-diphenylethan-1-one, 1-hydroxycyclohexyl phenyl ketone, 2-hydroxy-2-methyl-1-phenylpropan-1-one, 1-[4-(2 -hydroxyethoxy)-phenyl] -2 -hydroxy-2 -methyl-1 -propan-1 -one, 2-methyl-1-[4-(methylthio)phenyl]-2-morpholinopropan-1-one, 2-benzyl-2-dimethylamino-1-(4-morpholinophenyl)-butan-1-one, diethoxyacetophenone, oligo {2-hydroxy-2-methyl-1-[4-(1-methylvinyl)phenyl]propanone}, and 2-hydroxy-1-{4-[4-(2-hydroxy-2-methylpropionyl)benzyl]phenyl} -2-methylpropan-1-one.

Examples of the benzophenone-based compound include benzophenone, 4-phenylbenzophenone, 2,4,6-trimethylbenzophenone, and 4-benzoyl-4′-methyldiphenylsulfide. Examples of the α-ketoester-based compound include methylbenzoylformate, 2-(2-oxo-2-phenylacetoxyethoxy)ethyl ester of oxyphenylacetic acid, and 2-(2-hydroxyethoxy)ethyl ester of oxyphenylacetic acid.

Examples of the phosphine oxide-based compound include 2,4,6-trimethylbenzoyldiphenylphosphine oxide, bis(2,4,6-trimethylbenzoyl)phenylphosphine oxide, and bis(2,6-dimethoxybenzoyl)-2,4,4-trimethylpentylphosphine oxide. Examples of the benzoin compound include benzoin, benzoin methyl ether, benzoin ethyl ether, benzoin isopropyl ether, and benzoin isobutyl ether. Examples of the acetophenone/benzophenone hybrid-based photoinitiator include 1-[4-(4-benzoylphenylsulfanyl)phenyl]-2-methyl-2-(4-methylphenylsulfinyl)propane-1-one. Examples of the oxime ester-based photoinitiator include 2-(O-benzoyloxime)-1-[4-(phenylthio)]-1,2-octanedione.

As the component E, one compound selected from these compounds may be used, or two or more of these compounds may be used in combination.

### Component F: Ultraviolet Absorber

The coating agent may contain, as an optional component, a component F consisting of an ultraviolet absorber. The component F has a suppressing action on degradation of the coating film by ultraviolet rays. The content of the component F can be appropriately set within the range of 1 part by mass or more and 12 parts by mass or less based on 100 parts by mass of the film forming component. By setting the content of the component F in the coating agent to 1 part by mass or more, the weather resistance of the coating film after curing can be further improved.

On the other hand, an excessively large content of the component F may cause deterioration of the abrasion resistance of the coating film. Further, in this case, the weather resistance of the coating film may be rather deteriorated. By setting the content of the component F to 12 parts by mass or less, these problems can be avoided.

As the component F, for example, a triazine-based ultraviolet absorber, a benzotriazole-based ultraviolet absorber, a benzophenone-based ultraviolet absorber, a cyanoacrylate-based ultraviolet absorber, inorganic fine particles that absorb ultraviolet rays, or the like can be used.

Examples of the triazine-based ultraviolet absorber include 2-[4-{(2-hydroxy-3-dodecyloxypropyl)oxy}-2-hydroxyphenyl]-4,6-bis(2,4-dimethylphenyl)-l,3,5-triazine, 2-[4-{(2-hydroxy-3-tridecyloxypropyl)oxy}-2-hydroxyphenyl]-4,6-bis(2,4-dimethylphenyl)-1,3,5-triazine, 2-[4-{(2-hydroxy-3-(2-ethylhexyloxy)propyl)oxy}-2-hydroxyphenyl]-4,6-bis(2,4-dimethylphenyl)-1,3,5-triazine, 2,4-bis(2-hydroxy-4-butyroxyphenyl)-6-(2,4-bis-butyroxyphenyl)-1,3,5-triazine, and 2-(2-hydroxy-4-[1-octyloxycarbonylethoxy]phenyl)-4,6-bis(4-phenylphenyl)-1,3,5-triazine.

Examples of the benzotriazole-based ultraviolet absorber include 2-(2H-benzotriazole-2-yl)-4,6-bis(1-methyl-1-phenylethyl)phenol, 2-(2-hydroxy-5-tert-butylphenyl)-2H-benzotriazole, and 2-[2-hydroxy-5-{2-(meth)acryloyloxyethyl}phenyl]-2H-benzotriazole.

As the benzophenone-based ultraviolet ray, for example, 2,4-dihydroxybenzophenone, 2-hydroxy-4-methoxybenzophenone, or the like can be used. Examples of the cyanoacrylate-based ultraviolet absorber include ethyl-2-cyano-3,3-diphenylacrylate and octyl-2-cyano-3,3-diphenylacrylate. Examples of the inorganic fine particles include titanium oxide fine particles, zinc oxide fine particles, and tin oxide fine particles.

As the component F, one selected from the above-described compounds and inorganic fine particles may be used, or two or more thereof may be used in combination. As the component F, it is preferable to use a benzotriazole-based ultraviolet absorber having a (meth)acryloyl group. In this case, the weather resistance and abrasion resistance of the coating film can be improved in a well-balanced manner.

### Component G: Silicone-Based Surface Conditioner and Fluorine-Based Surface Conditioner

The coating agent may contain, as an optional component, a component G consisting of one or more compounds selected from silicone-based surface conditioners and fluorine-based surface conditioners. The content of the component G can be appropriately set within the range of 0.01 part by mass or more and 1 part by mass or less based on 100 parts by mass of the film forming component. By setting the content of the component G in the coating agent to 0.01 part by mass or more, the abrasion resistance of the coating film after curing can be further improved.

On the other hand, an excessively large content of the component G in the coating agent may cause deterioration of the appearance such as coarsening of the surface of the coating film after curing. Further, if the content of the component G increases, there is also a possibility of causing an increase in material cost. By setting the content of the component G to 1 part by mass or less, such a problem can be avoided.

As the component G, one or more compounds selected from silicone-based surface conditioners and fluorine-based surface conditioners can be used.

Examples of the silicone-based surface conditioner that can be used include: silicone-based polymers and silicone-based oligomers having a silicone chain and a polyalkylene oxide chain, silicone-based polymers and silicone-based oligomers having a silicone chain and a polyester chain; EBECRYL 350 and EBECRYL 1360 (each manufactured by DAICEL-ALLNEX LTD.); BYK-315, BYK-349, BYK-375, BYK-378, BYK-371, BYK-UV 3500 and BYK-UV 3570 (each manufactured by BYK JAPAN KK.); X-22-164, X-22-164AS, X-22-164A, X-22-164B, X-22-164C, X-22-164E, X-22-174DX, X-22-2426 and X-22-2475 (each manufactured by Shin-Etsu Chemical Co., Ltd.); AC-SQTA-100, AC-SQSI-20, MAC-SQTM-100, MAC-SQSI-20, and MAC-SQHDM (each manufactured by Toagosei Company, Limited); 8019 Additive (manufactured by Dow Corning Toray Co., Ltd.); and polysiloxane and dimethylpolysiloxane. “EBECRYL” is a registered trademark owned by DAICEL-ALLNEX LTD., and “BYK” is a registered trademark owned by BYK JAPAN KK.

Examples of the fluorine-based surface conditioner that can be used include: fluorine-based polymers and fluorine-based oligomers having a perfluoroalkyl group and a polyalkylene oxide group, and fluorine-based polymers and fluorine-based oligomers having a perfluoroalkyl ether group and a polyalkylene oxide group; MEGAFACE RS-75, MEGAFACE RS-76-E, MEGAFACE RS-72-K, MEGAFACE RS-76-NS, and MEGAFACE RS-90 (each manufactured by DIC Corporation); OPTOOL DAC-HP (manufactured by Daikin Industries, Ltd.); and ZX-058-A, ZX-201, ZX-202, ZX-212, and ZX-214-A (each manufactured by T&K TOKA CO., LTD.). “MEGAFACE” is a registered trademark owned by DIC Corporation, and “OPTOOL” is a registered trademark owned by Daikin Industries, Ltd.

### Organic Solvent

The coating agent may contain an organic solvent for dissolving or dispersing the components described above. Examples of the organic solvent that can be used include: alcohols such as ethanol and isopropanol; alkylene glycol monoethers such as ethylene glycol monomethyl ether, propylene glycol monomethyl ether, propylene glycol monoethyl ether, propylene glycol monopropyl ether, and propylene glycol monobutyl ether; aromatic compounds such as toluene and xylene; esters such as propylene glycol monomethyl ether acetate, ethyl acetate, and butyl acetate; ketones such as acetone, methyl ethyl ketone, and methyl isobutyl ketone; ethers such as dibutyl ether; diacetone alcohol; and N-methylpyrrolidone. The coating agent may contain one or more of these organic solvents.

It is preferable that the coating agent contains an alkylene glycol monoether as an organic solvent. Because the alkylene glycol monoether is excellent in ability to disperse or dissolve the above-described components, the substrate can be uniformly coated with the coating agent applied thereon. When the substrate includes polycarbonate, use of an alkylene glycol monoether as an organic solvent enables to form a coating without dissolving the substrate.

### Other Additives

In addition to the components A to E as essential components in the coating agent, additives for a coating agent may be contained as long as curing of the coating agent is not impaired. For example, the coating agent may contain, as an additive, an additive for suppressing degradation of the coating film, such as a radical scavenger or a hindered amine-based light stabilizer. An effect of improving the weather resistance of the coating film by using these additives can be expected.

### Resin Glass

When the coating agent for resin glass is applied to a surface of a substrate including transparent resin and then cured, it is possible to obtain resin glass including a substrate including transparent resin, and a coating film including a cured product of the coating agent for resin glass and covering a surface of the substrate. When the substrate has a plate shape, the coating film may be formed only on one surface or on both surfaces of the substrate. The thickness of the coating film is not particularly limited, and can be appropriately set within the range of, for example, 1 µm or more and 50 µm or less. The thickness of the coating film is preferably 5 µm or more and 40 µm or less.

Because the cured product of the coating agent is transparent, resin glass lighter than inorganic glass can be obtained by forming the coating film on a surface of a substrate including transparent resin. In addition, because the coating film has high hardness, the abrasion resistance of the resin glass can be improved. Further, the coating film is also excellent in toughness, and therefore if resin glass is thermally expanded, etc., the coating film easily follows the substrate, so that generation of cracks can be suppressed.

The transparent resin that forms the substrate is not particularly limited, and for example, polycarbonate can be employed. Polycarbonate is excellent in various properties required for transparent members for windows, such as weather resistance, strength, and transparency, and therefore resin glass suitable as a transparent member for windows can be obtained by forming the coating film on a surface of a substrate including polycarbonate.

For preparing the resin glass, for example, a production method can be employed which includes:
a provision step of providing a substrate;
an application step of applying a coating agent onto a surface of the substrate; and
a curing step of generating radicals from the component E in the coating agent to cure the coating agent on the surface of the substrate.

In the production method, an appropriate apparatus can be selected from known application apparatuses such as a spray coater, a flow coater, a spin coater, a dip coater, a bar coater, and an applicator according to a desired film thickness and a shape of the substrate, and the like, and used for application of the coating agent in the application step.

After the application step, a step of heating and drying the coating agent may be carried out if necessary.

In the curing step, radicals can be generated from the component E by irradiating the coating agent with light having an appropriate wavelength which depends on the molecular structure of the component E.

After the curing step, a step of heating the coating film to accelerate curing may be carried out if necessary.

### EXAMPLES

Examples of the coating agent and the resin glass will be described. The aspects of the coating agent and the resin glass according to the present invention are not limited to the following aspects, and the configuration can be appropriately changed without departing from the spirit of the present invention.

The coating agent of the present example includes:
a film forming component including a component A consisting of a urethane (meth)acrylate having an isocyanuric ring skeleton, a component B consisting of a tri(meth)acrylate having an isocyanuric ring skeleton and having no urethane bond, a component C consisting of a polymerizable urethane which has a polycarbonate skeleton derived from a polycarbonate diol having an alicyclic structure, 3 or more polymerizable unsaturated groups per molecule, a weight average molecular weight of 10,000 or more and 40,000 or less, and a content ratio of the alicyclic structure of 10 mass% or more and 25 mass% or less, and a component D consisting of colloidal silica having a (meth)acryloyl group; and
a component E consisting of a photoradical polymerization initiator.

The content of the component E is 0.1 parts by mass or more and 10 parts by mass or less based on 100 parts by mass of the total film forming component.

The specific compounds used for preparing the coating agent in the present example are as follows.

### Component A

A-1: Addition product of nurate-type trimer of hexamethylene diisocyanate and hydroxyalkyl (meth)acrylate.

### Component B

B-1: M-315 (mixture containing isocyanuric acid ethylene oxide-modified triacrylate, manufactured by Toagosei Company, Limited)

### Component C

C-1: Urethane acrylate (“UA0581” manufactured by Ube Industries, Ltd.)
C-2: Urethane acrylate (“UA0499B” manufactured by Ube Industries, Ltd.)
C-3: Urethane acrylate (“UA0582B-30” manufactured by Ube Industries, Ltd.)
C-4: Urethane acrylate (“UA0592B” manufactured by Ube Industries, Ltd.)
C-5: Urethane acrylate (“UA0503B” manufactured by Ube Industries, Ltd.)
C-6: Urethane acrylate (“UA0505B” manufactured by Ube Industries, Ltd.)
C-7: Urethane acrylate (“UA0500B” manufactured by Ube Industries, Ltd.)

All of C-1 to C-7 described above are reaction products of a polycarbonate polydiol (c1) including a polycarbonate skeleton having an alicyclic structure, a polyisocyanate compound (c2), and a polymerizable unsaturated compound (c3).

Table 1 shows the weight average molecular weight, the number of polymerizable unsaturated groups per molecule, the content ratio of the alicyclic structure in the component C, the content ratio of the alicyclic structure in the polycarbonate diol (c1), and the polyisocyanate compound (c2) and the polymerizable unsaturated compound (c3) used, for C-1 to C-7. The content ratio of the alicyclic structure in the component C in Table 1 is a value of a ratio of the content of all alicyclic structures present in the component C to the content of the component C, where the ratio is expressed in percentage. The content ratio of the alicyclic structure in the polycarbonate diol (c 1) in Table 1 is a value of a ratio of the content of alicyclic structures present in the polycarbonate diol (c1) to the content of the component C, where the ratio is expressed in percentage.

### Component D

D-1: Colloidal silica having (meth)acryloyl group and hydrocarbon group

### Component E

E-1: Omnirad 754 (phosphine oxide-based photoradical polymerization initiator manufactured by IGM Resins B.V.)
E-2: Omnirad 819 (photoradical polymerization initiator containing α-ketoester-based compound, manufactured by IGM Resins B.V.)

### Component F

RUVA-93 (benzotriazole-based ultraviolet absorber manufactured by Otsuka Chemical Co., Ltd.) and Tinuvin 479 (hydroxyphenyltriazine-based ultraviolet absorber manufactured by BASF SE)

### Component G

8019 Additive (silicone-based surface conditioner manufactured by Dow Corning Toray Co., Ltd.)

### Other Components

Tinuvin 152 (hindered amine-based light stabilizer manufactured by BASF SE)
SeRM Super Polymer SM3403P (rotaxane manufactured by ASM)

“Omnirad” is a registered trademark owned by IGM Group B.V., “Tinuvin” is a registered trademark owned by BASF, and “SeRM” is a registered trademark owned by ASM.

Table 2 shows examples of compositions of coating agents prepared using these compounds (test agents 1 to 10). For preparing the test agents 1 to 10, each component may be dissolved or dispersed in an organic solvent at a mass ratio shown in Table 2. Test agents 11 to 14 shown in Table 2 are test agents for comparison with test agents 1 to 10. The methods for preparation of test agents 11 to 14 are the same as the methods for preparation of test agents 1 to 10 except that the mass ratio of each component is changed as shown in Table 2.

Next, an example of a method for preparation of resin glass using a coating agent will be described. First, a substrate to be coated with the coating agent is provided. The substrate for use in the present example is a plate material including polycarbonate and having a plate thickness of 5 mm.

The coating agent is applied onto one surface of the substrate using a flow coater, and the substrate is then heated at a temperature of 100° C. for 10 minutes to dry the coating agent. Thereafter, by generating radicals from the component E in the coating agent, the coating agent can be cured to obtain a coating film. For test agents 1 to 14 shown in Table 2, for example, the test agents may be irradiated with ultraviolet light generated from a high-pressure mercury lamp having a peak illumination intensity of 300 mW/cm².

In this way, a coating film including a cured product of the test agent can be formed on one surface of the substrate to obtain resin glass.

The toughness and abrasion resistance of the coating film can be evaluated by the following methods.

### Abrasion Resistance

The abrasion resistance of the coating film can be evaluated on the basis of the amount of increase in haze value ΔH (unit: %) before and after the abrasion test. In the abrasion test, resin glass whose haze value has been measured before the test in advance is attached to a Taber’s abrasion tester. Then, the coating film on the resin glass is abraded using an abrasion wheel. The abrasion wheel of the Taber’s abrasion tester in the present example is CS-10F. The load in the abrasion test is set 500 gf, and the number of rotations is set 500.

After the abrasion test is conducted under the above-described conditions, the haze value of the resin glass after the test is measured using a haze meter. A value obtained by subtracting the haze value of the resin glass before the test from the haze value of the resin glass after the test is defined as the amount of increase in haze value. The amount of increase in haze value ΔH for the coating film obtained using each test agent is shown in Table 2. In the evaluation of abrasion resistance, a coating film for which the amount of increase in haze value ΔH is 10% or less is considered as having sufficiently high abrasion resistance and rated acceptable, and a coating film for which the amount of increase in haze value ΔH is more than 10% is considered as having poor abrasion resistance and rated unacceptable.

### Toughness of Coating Film

The toughness of the coating film can be evaluated on the basis of breaking strain (unit: %) in a three-point bending test conducted on resin glass, i.e. the magnitude of strain at the time of generation of cracks in the coating film. In the three-point bending test, the resin glass need only be curved in such a manner that the resin glass is projected on a side where the coating film is provided. The value of breaking strain for the coating film obtained using each test agent is shown in the “toughness” section of Table 2.

TABLE 1

| | Weight Average Molecular Weight | Number of Polymerizable Unsaturated Groups per Molecule | Content Ratio of Alicyclic Structure in Component C (mass%) | Contaent Ratio of Alicyclic Structure in Polycarbonate Diol (c1) (mass %) | Ppolyisocyanate Compound (c2) | Polymerizable Unsaturated Compound (c3) |
|---|---|---|---|---|---|---|
| C-1 | 10800 | 6 | 16.6 | 8.8 | Alicyclic Diisocyanate | Pentaerythritol Triacrylate |
| C-2 | 14100 | 6 | 18.0 | 102 | Alicyclic Diisocyanate | Pentaerythritol Triacrylate |
| C-3 | 20100 | 6 | 18.3 | 10.7 | Alicyclic Diisocyanate | Pentaerythritol Triacrylate |
| C-4 | 16000 | 10 | 16.1 | 9.1 | Alicyclic Diisocyanate | Dipentaerythritol Pentaacrylate |
| C-5 | 14300 | 6 | 18.9 | 11.7 | Alicyclic Diisocyanate | Pentaerythritol Triacrylate |
| C-6 | 14100 | 6 | 16.0 | 8.7 | Alicyclic Diisocyanate | Pentaerythritol Triacrylate |
| C-7 | 14400 | 6 | 10.3 | 10.3 | Aliphatic Diisocyanate | Pentaerythritol Triacrylate |

TABLE 2

| | | | Test Agent 1 | Test Agent 2 | Test Agent 3 | Test Agent 4 | Agent 5 | Test Agent 6 | Test Agent 7 | Test Test Agent 8 | Test Agent 9 | Test Agent 10 | Test Test Agent 11 | Test Test Agent 12 | Test Agent 13 | Test Agent 14 |
|---|---|---|---|---|---|---|---|---|---|---|---|---|---|---|---|---|
| Component A | A-1 | Parts by Mass | 50 | 50 | 50 | 50 | 50 | 50 | 50 | 15 | 10 | 5 | 50 | 40 | 37 | 33 |
| Component B | B-1 | Parts by Mass | 25 | 25 | 25 | 25 | 25 | 25 | 25 | 40 | 40 | 40 | 40 | 32 | 30 | 27 |
| Component C | C-1 | Parts by Mass | 20 | - | - | - | - | - | - | 30 | 35 | 40 | - | - | - | - |
| | C-2 | Parts by Mass | - | 20 | - | - | - | - | - | - | - | - | - | - | - | - |
| | C-3 | Parts by Mass | - | - | 20 | - | - | - | - | - | - | - | - | - | - | - |
| | C-4 | Parts by Mass | - | - | - | 20 | - | - | - | - | - | - | - | - | - | - |
| | C-5 | Parts by Mass | - | - | - | - | 20 | - | - | - | - | - | - | - | - | - |
| | C-6 | Parts by Mass | - | - | - | - | - | 20 | - | - | - | - | - | - | - | - |
| | C-7 | Parts by Mass | - | - | - | - | - | - | 20 | - | - | - | - | - | - | |
| Component D | D-1 | Parts by Mass | 5 | 5 | 5 | 5 | 5 | 5 | 5 | 5 | 5 | 5 | 10 | 8 | 7 | 7 |
| Component E | E-1+E-2 | Parts by Mass | 2.5 | 2.5 | 2.5 | 2.5 | - | 2.5 | 2.5 | 2.5 | 2.5 | 2.5 | 2.5 | 2.5 | 2.5 | 2.5 |
| Rotaxane | | Parts by Mass | - | - | - | - | - | - | - | 10 | 10 | 10 | -- | 20 | 26 | 33 |
| Abrasion Resistance | ◢H | % | 5.1 | 5.0 | 5.6 | 6.6 | 5.1 | 5.5 | 5.2 | 5.3 | 6.7 | 8.2 | 4.6 | 11.3 | 12.3 | 14.1 |
| Toughness | BreakngStrain | % | 9.7 | 10.1 | 10.5 | 10.4 | 10.2 | 10.2 | 10.4 | 9.7 | 10.5 | 11.5 | 5.5 | 8.1 | 9.2 | 10.8 |

As shown in Table 2, test agents 1 to 10 contain all the components A to E described above. Thus, the coating films including these test agents have excellent abrasion resistance and excellent toughness.

The test agent 11 is generally similar in composition to test agents 1 to 7 except that the component C is not contained. Comparison of test agents 1 to 7 with the test agent 11 shows that the test agent 11 is comparable in abrasion resistance to test agents 1 to 7, but inferior in toughness to test agents 1 to 7.

Test agents 12 to 14 contain a relatively large amount of rotaxane for the purpose of enhancing the toughness of the coating film. Thus, coating films formed from these test agents are softer and poorer in abrasion resistance as compared to those formed from test agents 1 to 7 and 11 which are free of rotaxane.

Comparison of test agents 12 to 14 with test agents 8 to 10 containing rotaxane like these test agents shows that the contents of rotaxane in test agents 8 to 10 is smaller than those in test agents 12 to 14. However, test agents 8 to 10 contain the component C having a toughness enhancing action, and therefore enables abrasion resistance to be improved with the rotaxane content made smaller than that in each of test agents 12 to 14 while toughness is secured.

From the above results, it can be understood that a coating film having both high hardness and excellent toughness can be formed by blending the component C in the film forming component.

1. A coating agent for resin glass comprising:
a film forming component including
a component A consisting of a urethane (meth)acrylate having an isocyanuric ring skeleton,
a component B consisting of a tri(meth)acrylate having an isocyanuric ring skeleton and having no urethane bond,
a component C consisting of a polymerizable urethane which has
a polycarbonate skeleton derived from a polycarbonate diol having an alicyclic structure,
3 or more polymerizable unsaturated groups per molecule,
a weight average molecular weight of 10,000 or more and 40,000 or less, and
a content ratio of the alicyclic structure of 10 mass% or more and 25 mass% or less, and
a component D consisting of colloidal silica having a (meth)acryloyl group; and
a component E consisting of a photoradical polymerization initiator,
wherein a content of the component E is 0.1 parts by mass or more and 10 parts by mass or less based on 100 parts by mass of the total film forming component.

2. The coating agent for resin glass according to claim 1, wherein a content of the component A is 3 parts by mass or more and 60 parts by mass or less, a content of the component B is 10 parts by mass or more and 50 parts by mass or less, a content of the component C is 10 parts by mass or more and 50 parts by mass or less, and a content of the component D is 1 part by mass or more and 30 parts by mass or less, based on 100 parts by mass of the total film forming component.

3. The coating agent for resin glass according to claim 1, wherein the coating agent for resin glass further contains a component F consisting of an ultraviolet absorber, and a content of the component F is 1 part by mass or more and 12 parts by mass or less based on 100 parts by mass of the total film forming component.

4. The coating agent for resin glass according to claim 1, wherein the coating agent for resin glass further contains a component G consisting of one or more compounds selected from silicone-based surface conditioners and fluorine-based surface conditioners, and a content of the component G is 0.01 parts by mass or more and 1.0 parts by mass or less based on 100 parts by mass of the total film forming component.

5. Resin glass comprising:
a substrate including transparent resin; and
a coating film including a cured product of the coating agent for resin glass according to claim 1, and covering a surface of the substrate.

6. The resin glass according to claim 5, wherein the substrate includes polycarbonate as the transparent resin.
